(19) United States
(12) Patent Application Publication
(10) Pub. No.: US 2013/0093670 A1
(43) Pub. Date: Apr. 18, 2013

(54) IMAGE GENERATION DEVICE, METHOD, AND INTEGRATED CIRCUIT

(71) Applicant: Panasonic Corporation, Osaka (JP)

(72) Inventor: Yasuhiro IWAI, Osaka (JP)

(73) Assignee: Panasonic Corporation, Osaka (JP)

(21) Appl. No.: 13/693,759

(22) Filed: Dec. 4, 2012

Related U.S. Application Data
(63) Continuation of application No. PCT/JP2011/003227, filed on Jun. 8, 2011.

(30) Foreign Application Priority Data
Jun. 8, 2010 (JP) 2010-131541

(51) Int. Cl. G06F 3/01

(52) U.S. Cl. CPC G06F 3/017
USPC 345/156

(57) ABSTRACT

When a television screen is split into sub-screens and the sub-screens are allocated to a plurality of operators, a television appropriately controls display positions and sizes of the sub-screens according to a position relationship between the operators, distances between the operators and the sub-screens, and rearrangement of the positions of the operators. Specifically, the television includes an external information obtaining unit that obtains position information items of the gesture operations and a generation unit that generates an image in a layout set based on a relative position relationship between the position information items.

### CROSS REFERENCE TO RELATED APPLICATIONS

This is a continuation application of PCT Patent Application No. PCT/JP2011/003227 filed on Jun. 8, 2011, designating the United States of America, which is based on and claims priority of Japanese Patent Application No. 2010-131541 filed on Jun. 8, 2010. The entire disclosures of the above-identified applications, including the specifications, drawings and claims are incorporated herein by reference in their entirety.

### FIELD

The present disclosure relates to an image generation device, an image generation method, and an integrated circuit that generates an image.

### BACKGROUND

Some televisions have a dual display function or a function called a picture-in-picture function. The function is a function for improving the convenience of a user by splitting a television screen into a plurality of areas and assigning different display applications to the respective areas (for example, displaying two different broadcasts). However, the dual display function has some problems when the user operates it using a remote control. When a plurality of users view respective screen areas, only one of the users who holds the remote control in his/her hand can operate the screen. In other words, each time the user operates the screen, it is necessary to pass the remote control among the users. Furthermore, before operating the screen, there is a problem that the user needs to designate a screen area to be operated, which complicates the operation.

PTL 1 discloses the conventional technique for solving such a problem caused by operating the television screens by the respective users, using one remote control. According to PTL 1, transmission sources of remote control signals are identified, and a display screen is split into (i) a first display screen to be operated using a first remote control at a transmission source of a previously received remote control signal, and (ii) a second display screen to be operated using a second remote control at a transmission source of a new remote control signal. Then, the position and the size of each of the display screens to be operated using a corresponding one of the remote controls at the transmission source are determined, based on the reception order of the remote control signals. Thus, PTL 1 discloses the technique for simultaneously operating the display screens of the television using a plurality of remote controls.

### CITATION LIST

### Patent Literature

[PTL 1] Japanese Unexamined Patent Application Publication No. 2008-011050

### SUMMARY

### Technical Problem

Here, a system that operates a television using a gesture operation has been considered. Since the gesture operation does not require a device such as a remote control, it is likely that the users simultaneously operate respective screens of the television. Thus, it is necessary to control the television so as to appropriately reflect the intention of the gesture operation of each of the users on an operation on the television. Although the technique on the television to which the gesture operation is performed is identical to that of PTL 1 in that display screens are simultaneously operated, the gesture operation has additional problems in view of the convenience of the users.

In other words, the system reflects the intuitive gesture operation of each operator. The position relationship between a television screen and the operator is important. Thus, split screens and respective positions of the operators need to be appropriately associated with each other and controlled.

One non-limiting and exemplary embodiment provides an image generation device that splits a television screen and that, when the split screens are allocated to operators, appropriately controls display positions and sizes of the split screens, according to a position relationship between the operators, distances from the operators to the screen, or rearrangement of the positions of the operators.

The present inventor has conceived another technique for displaying an image viewed by the user, for example, on a surface of a wall of a building. It is assumed that the portion to be displayed on the wall is a portion in front of the user from among portions. Furthermore, it is assumed that a screen for one of the users is in front of the user and that a screen for the other user is in front of the other user.

The users in front of the television are often relatively closer to each other than the users in front of the wall. Furthermore, when the users can only move within a living room including the television, it is often difficult to keep appropriate distances between the users.

When the users are closer to each other, once an image for one user is displayed in front of the users, the image is sometimes displayed in an inappropriate portion of the screen, such as overlapping of the image with an image of the other user. In other words, the images cannot be appropriately displayed based on a relative position relationship between the users.

Accordingly, another non-limiting and exemplary embodiment provides an image generation device that can appropriately and reliably display an image regardless of a relative position relationship between the users.

### Solution to Problem

In order to solve the problems, the image generation device according to the present disclosure includes: an information obtaining unit configured to obtain position information items indicating positions of operators who perform gesture operations (positions at which the operators perform the gesture operations); and an image generation unit configured to set a layout of an image, based on a relative position relationship between the positions of the operators that are indicated by the obtained position information items, and generate the image (image signal) in the set layout corresponding to the position relationship. As such, the number of operators who perform gesture operations is more than one.

In other words, the information obtaining unit obtains a plurality of position information items. Each of the position information items to be obtained may indicate a position at which the gesture operation has been performed. The position information items may correspond to a plurality of gesture operations. Furthermore, two different position information items may correspond to two different gesture operations.

Here, the layout to be set is, for example, a layout in which a display area (1011P in the right section of FIG. 3) is split, in a predetermined direction (Dx), into a plurality of operation areas (screens 1012 and 1013) at positions (P1 and P2) having different coordinates in the direction Dx. Specifically, the display area may be split into operation areas at the positions having different coordinates in the direction (Dx).

### Advantageous Effects

When a television screen is split into sub-screens and the sub-screens are allocated to a plurality of operators, display positions and sizes of the sub-screens are appropriately controlled according to a position relationship between the operators, distances between the operators and the sub-screens, and rearrangement of the positions of the operators. Accordingly, an image is appropriately and reliably displayed regardless of a relative position relationship between the operators.

### BRIEF DESCRIPTION OF DRAWINGS

These and other objects, advantages and features of the invention will become apparent from the following description thereof taken in conjunction with the accompanying drawings that illustrate a specific embodiment of the present disclosure.

FIG. 1 illustrates a configuration of a television operating system by gesture recognition according to Embodiments 1, 2, and 3 in the present disclosure.

FIG. 2 is a block diagram illustrating a configuration of a television according to Embodiment 1.

FIG. 3 illustrates a screen display of the television according to Embodiment 1.

FIG. 4 illustrates a screen display of the television according to Embodiment 1.

FIG. 5 illustrates a screen display of the television according to Embodiment 1.

FIG. 6 is a block diagram illustrating a configuration of a television according to Embodiment 2.

FIG. 7 illustrates a screen display of the television according to Embodiment 2.

FIG. 8 is a block diagram illustrating a configuration of a television according to Embodiment 3.

FIG. 9 illustrates a set-top box and a television.

FIG. 10 is a flowchart of operations on a television.

FIG. 11 illustrates three operators and others.

FIG. 12 illustrates a television and others.

FIG. 13 illustrates a television and others.

### DESCRIPTION OF EMBODIMENTS

Embodiments according to the present disclosure will be described with reference to the drawings.

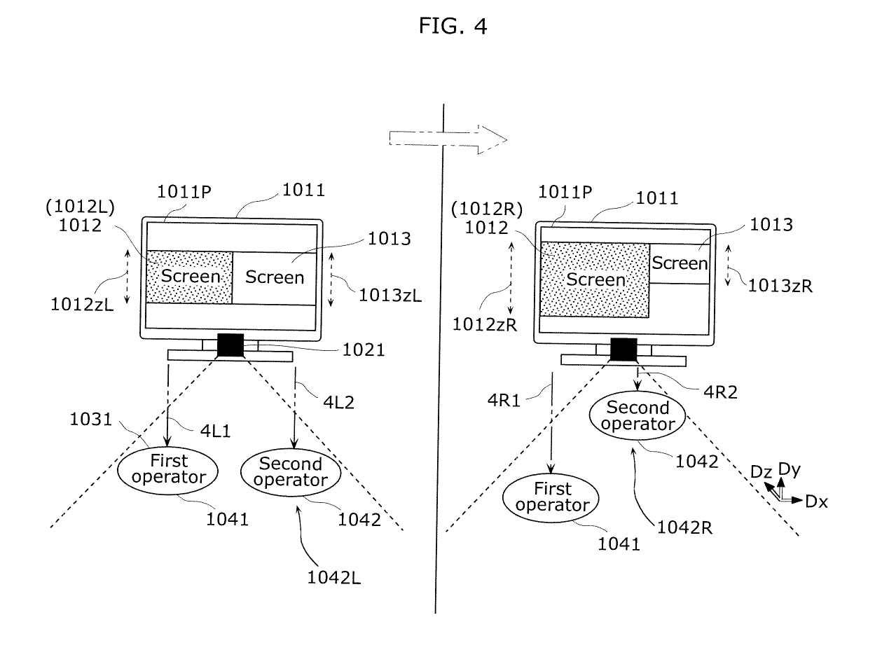

The image generation device according to Embodiments includes: an information obtaining unit (external information obtaining unit 2030) configured to obtain position information items (10211) indicating positions of operators who perform gesture operations; and an image generation unit (generation unit 2020x) configured to set a layout of an image (image of a display area 1011P), based on a relative position relationship between the positions of the operators (for example, relationship in which an operator 1042 is closer to a television 1011 than an operator 1041 as in the right section of FIG. 4) that are indicated by the obtained position information items, and generate the image (image signal) in the set layout (determined by lengths 1012zR and 1013zR in the right section of FIG. 4) corresponding to the position relationship.

In other words, the image generation device may generate (i) the first image in the first layout appropriate for the first position relationship when the obtained position information items indicate the first position relationship (for example, left section of FIG. 4), and (ii) the second image in the second layout appropriate for the second position relationship when the obtained position information items indicate the second position relationship (for example, right section of FIG. 4).

Accordingly, images are appropriately displayed regardless of a position relationship between the users.

Specifically, for example, the position of the first operator 1041 at one time (time in the right section of FIG. 4) is identical to that of the first operator 1041 at another time (time in the left section). Furthermore, for example, the position (position 1042R) of the second operator 1042 at one time is different from the position (1042L) of the second operator 1042 at the other time. Although the position of the first operator remains the same, the position of the second operator is different from the position at another time. Accordingly, an operation area (the screen 1012R different in size from the screen 1012L) different from the operation area (screen 1012L) of the first operator is set at one time. Accordingly, an appropriate operation area (screen 1012R) is set at the other time not only when the two operators are at the same position and have the same position relationship but also when the two operators are at different positions and have different position relationships. Accordingly, images are appropriately displayed regardless of a position relationship between the users.

An image generation unit included in the image generation device (television 1011) may include (i) a control unit 2040 that selects a layout and sets the selected layout as a layout of an image to be generated and (ii) a screen output unit 2020 that generates the image (image signal) in the set layout, outputs the generated image to a display panel 2020p, and causes the display panel 2020p to display the image.

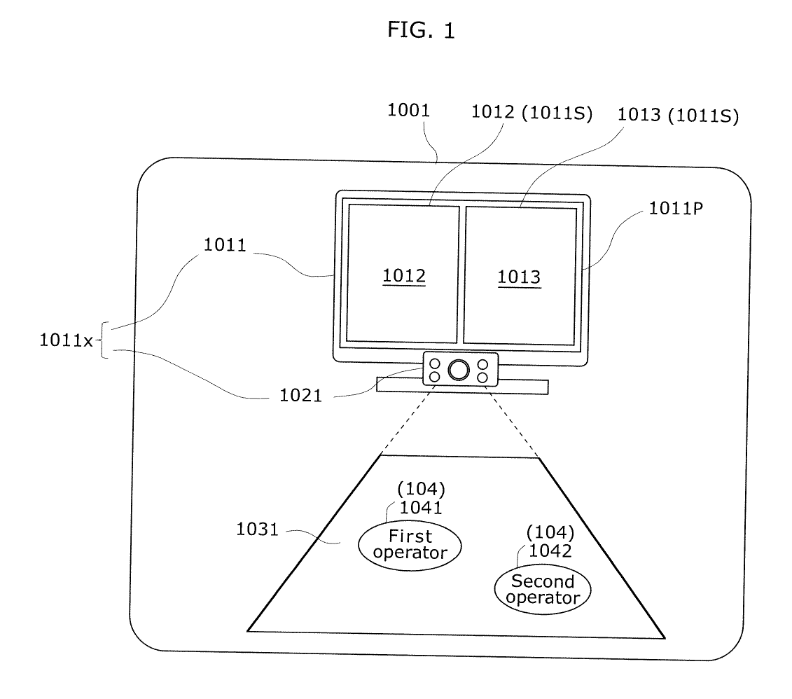

Specifically, for example, an information obtaining unit included in the image generation device may capture respective images of users (for example, two operators 1041 and 1042 in FIG. 4) and obtain, from results of the capturing, respective types of gesture operations of the users (for example, gesture operation information items on turning ON/OFF and switching between channels) and a position information item of each position of the gesture operation performed by the user. Furthermore, the information obtaining unit may include a display unit (display panel 2020p) that displays the generated image. The image generation device is a display device (television 1011) including the display unit that displays the generated image. Furthermore, the image generation unit may set an operation area (screen 1011S in FIG. 1 and others) operated by a gesture operation to a display area (1011P) of the display unit on which the generated image is to be displayed, set, to the display area, a plurality of operation areas (screens 1011S having the same number as that of gesture operations) according to the number of obtained gesture operations, and change display positions and display sizes of the operation areas in the display area, based on one or more position information items corresponding to the operation areas.

The image generation unit may generate the image including the operation areas, in the layout that corresponds to the position relationship, each of the operation areas being at a display position (to the left) and having a display size (length 1012zR) as in the left section of FIG. 4.

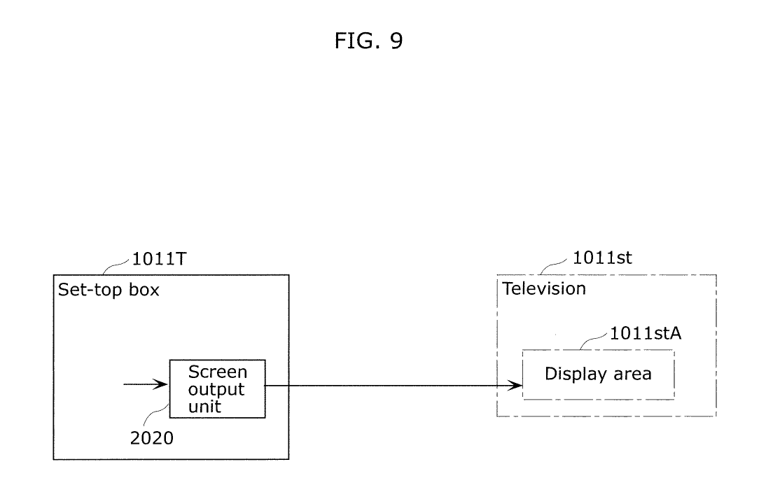

The image generation device may be a set-top box (1011T) that displays the generated image on a display area (1011stA) of a television (1011st) placed outside of the image generation device as illustrated in FIG. 9.

Here, the image generation unit may be configured to: generate a first image in a first layout when the position relationship is a first position relationship (left section of FIG. 4), and perform first control for outputting a first sound (for example, sound of the left screen 1012) corresponding to the first image (for example, control for outputting a sound with a volume identical to that of a sound of the right screen 1013); and generate a second image in a second layout when the position relationship is a second position relationship (right section of FIG. 4), and perform second control for outputting a second sound (for example, sound of the right screen 1013) corresponding to the second image (for example, control for outputting a sound with a volume larger than that of the sound of the right screen 1013).

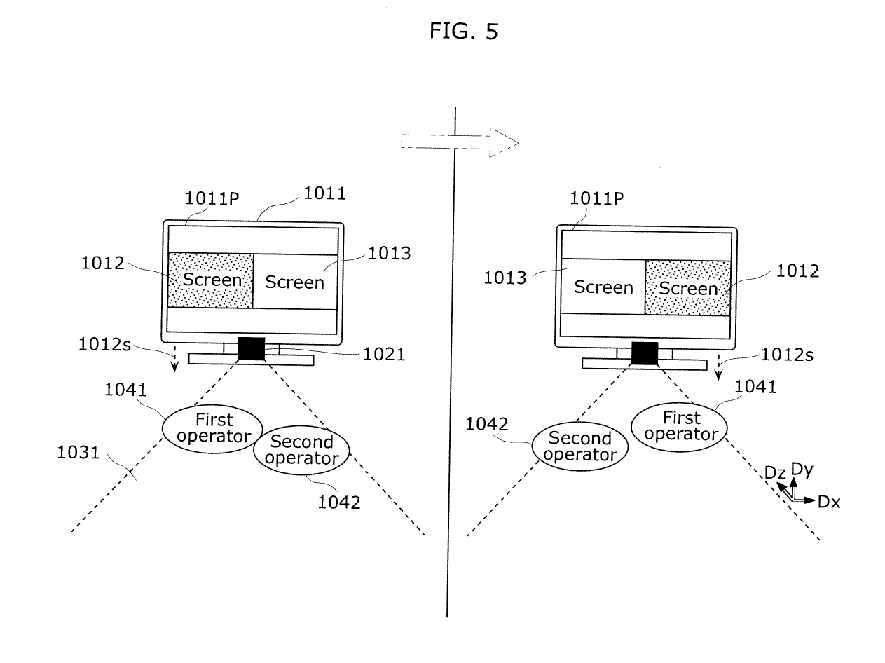

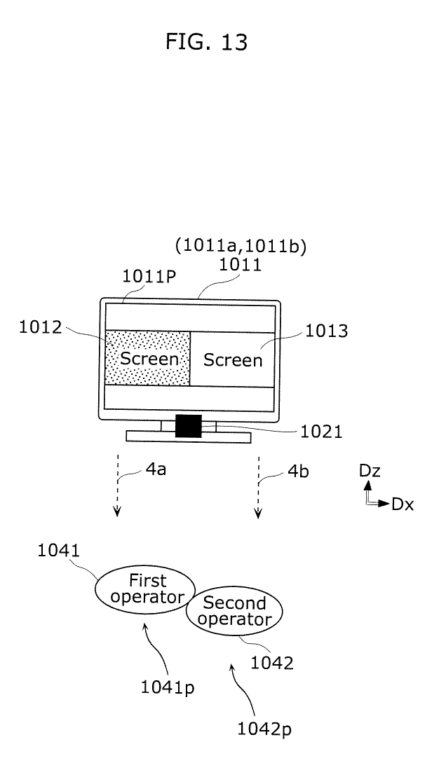

Furthermore, the first control (for example, control in the left section of FIG. 5) may be control for outputting the first sound (for example, sound of the left screen 1012) from one of two speakers (for example, speakers 1011a and 1011b in FIG. 13), and the second control (for example, control in the right section of FIG. 5) may be control for outputting the second sound (sound 1012s) from the other speaker (right speaker 1011b).

Regardless of generation of an image in a layout corresponding to a position relationship, output of a sound can be appropriately controlled.

Accordingly, when the television 1011 outputs information (image and sound, etc.) to the operator, it can appropriately control the output, such as a layout of the image and output of the sound, to correspond to the position relationship between the operators.

### Embodiment 1

FIG. 1 illustrates a configuration of a television operating system 1001 using gesture recognition according to Embodiment 1 in the present disclosure.

The television operating system 1001 using gesture recognition includes a television 1011 and a gesture recognition sensor 1021 (two devices indicated by codes 1011x).

The gesture recognition sensor 1021 is normally placed near the television 1011.

A first operator 1041 and a second operator 1042 can perform an operation, such as turning ON and OFF of the television 1011 and switching between channels, by performing a predetermined gesture operation within a gesture recognition range 1031.

Furthermore, the television 1011 has a screen splitting function of having a screen 1012 and a screen 1013 that can be used separately, for example, for simultaneously viewing two broadcasts.

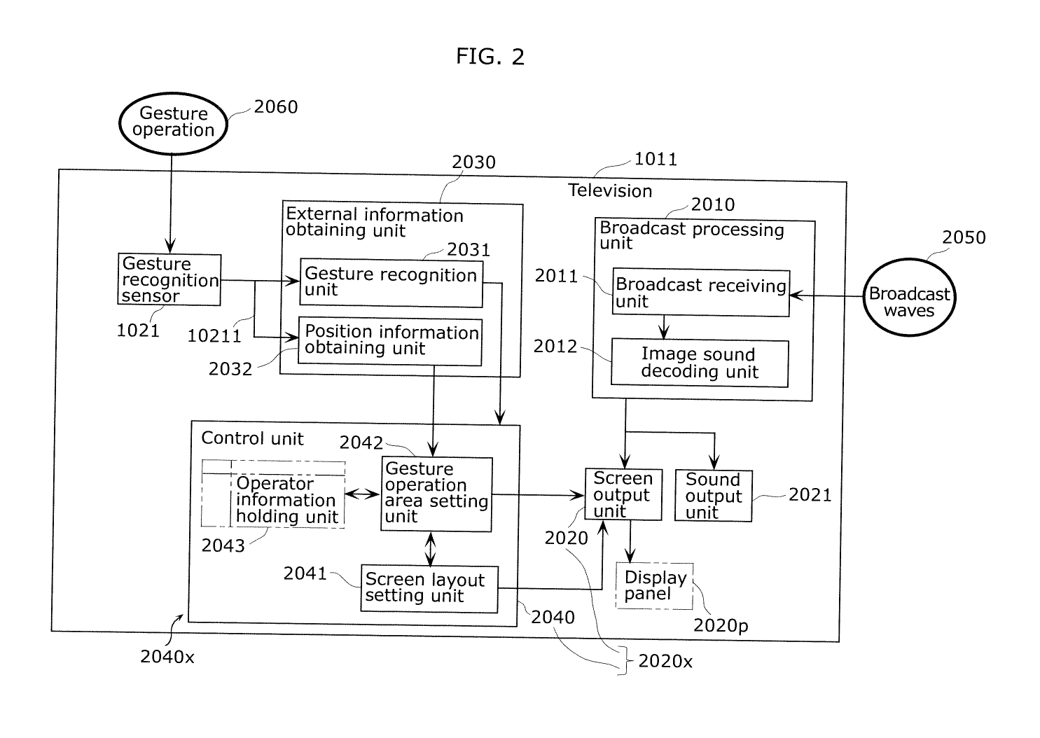

FIG. 2 is a block diagram illustrating a configuration of the television 1011 that is a display device (image generation device) according to Embodiment 1. The television 1011 includes (i) a broadcast processing unit 2010 including a broadcast receiving unit 2011 and an image sound decoding unit 2012, (ii) an external information obtaining unit 2030 including a gesture recognition unit 2031 and a position information obtaining unit 2032, (iii) a control unit 2040 including a screen layout setting unit 2041, a gesture operation area setting unit 2042, and an operator information holding unit 2043, (iv) the gesture recognition sensor 1021, (v) a screen output unit 2020, and (vi) a sound output unit 2021.

The broadcast processing unit 2010 receives and displays a television broadcast.

The broadcast receiving unit 2011 receives, demodulates, and descrambles broadcast waves 2050, and provides the broadcast waves 2050 to the image sound decoding unit 2012.

The image sound decoding unit 2012 decodes image data and sound data that are included in the broadcast waves 2050, and outputs an image to the screen output unit 2020 and a sound to the sound output unit 2021.

The external information obtaining unit 2030 processes data provided from the gesture recognition sensor 1021, and outputs a gesture command and a position information item of the user.

The gesture recognition sensor 1021 may be, for example, a part of the television 1011 as illustrated in FIG. 2.

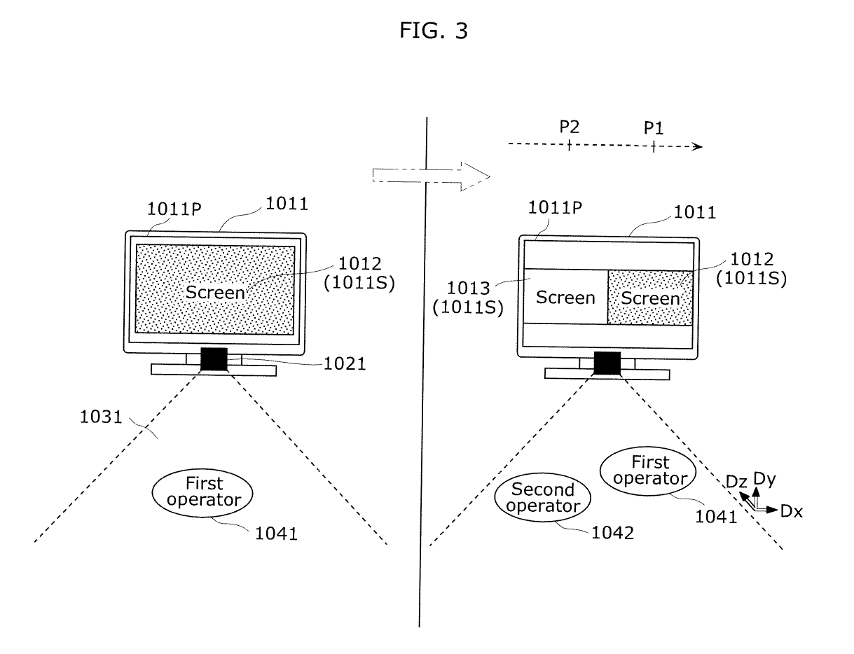

The gesture recognition sensor 1021 has various modes. Here, a mode for recognizing a gesture using a 2D image in combination with a depth image (image representing a distance from the gesture recognition sensor 1021 to the operator in a depth direction, for example, the direction Dz in FIG. 3) will be described as an example.

The first operator 1041 in FIG. 1 performs a predetermined gesture operation corresponding to each television operation, toward the gesture recognition sensor 1021 within the gesture recognition range 1031, when he/she desires to perform an operation, such as turning ON/OFF the television and switching between the channels.

The gesture recognition unit 2031 detects a body movement of the operator from the 2D image and the depth image provided from the gesture recognition sensor 1021. Then, the gesture recognition unit 2031 recognizes, using pattern recognition, the detected movement as a particular gesture command corresponding to a television operation.

The position information obtaining unit 2032 in FIG. 2 recognizes a position information item of a horizontal direction (direction Dx in FIG. 3) from the 2D image provided from the gesture recognition sensor 1021. At the same time, the position information obtaining unit 2032 recognizes a position information item of a depth direction from the depth image to output a position information item indicating a position of the operator in front of the television 1011.

The control unit 2040 receives the gesture command and the position information items that are output from the external information obtaining unit 2030.

Upon receipt of the gesture command from the external information obtaining unit 2030, the gesture operation area setting unit 2042 included in the control unit 2040 sets a gesture operation area (screen 1011S) on the screen (display area 1011P) of the television 1011, based on the position information item of the operator. Here, the gesture operation area setting unit 2042 stores, in the operator information holding unit 2043, association information between a gesture operation area and an operator corresponding to the gesture operation area. The gesture operation area setting unit 2042 notifies the screen layout setting unit 2041 of the set gesture operation area.

The screen layout setting unit 2041 lays out the television screen (display area 1011P) such as splitting it into two screens (for example, screens 1012 and 1013), and the screen output unit 2020 combines each of the screens with an image of a television broadcast to display the combined image on the television screen. In other words, the screen output unit 2020 displays an image of a television broadcast of a channel corresponding to each of the two screens 1012 and 1013, within the display area 1011P.

FIG. 3 illustrates a screen display of the television 1011 according to Embodiment 1.

First, consider only a case where the first operator 1041 is present within the gesture recognition range 1031 of the television 1011 (left section). For example, the gesture operation area setting unit 2042 allocates the screen 1012 that is an entire of the screen of the television 1011 as a gesture operation area of the first operator 1041. With this allocation, the television 1011 processes the gesture operation of the first operator 1041 as the gesture operation on the screen 1012.

Then, when the second operator 1042 enters the gesture recognition range (area) 1031 (right section), the position information obtaining unit 2032 provides the gesture operation area setting unit 2042 with the position information items of the first operator 1041 and the second operator 1042. Here, the second operator 1042 is located to the left of the first operator 1041 toward the television 1011, that is, to the left when the second operator 1042 is oriented to the direction Dz. The distance between the second operator 1042 and the television 1011 (distance in the direction Dz) is almost identical to that between the first operator 1041 and the television 1011.

The two position information items can identify a relative position relationship between the two operators, such as the second operator 1042 located to the left. Here, identifying the position relationship may lead to identification of a relative position of an operator having such a position relationship, such as the second operator 1042 located to the left.

The gesture operation area setting unit 2042 sets the screen of the television 1011 (display area 1011P) to two displays of the screen 1012 (right side with respect to the operator) and the screen 1013 (left side with respect to the operator), based on the two position information items. At the same time, the gesture operation area setting unit 2042 stores, in the operator information holding unit 2043, association information of each pair of (i) the screen 1012 and the first operator 1041 and (ii) the screen 1013 and the second operator 1042, in association with a left-right relationship (relationship in which the second operator 1042 is to the left of the first operator 1041).

FIG. 4 illustrates another screen display of the television 1011 according to Embodiment 1.

The first operator 1041 is to the left of the second operator 1042 toward the television 1011, and a distance between the television 1011 and the first operator 1041 is almost identical to that between the television 1011 and the second operator 1042 (left section in FIG. 4). In this case, with the processing described in FIG. 3, the screen 1012 and the screen 1013 are allocated to the first operator 1041 and the second operator 1042, respectively.

Here, assume a case where the second operator 1042 approaches the television 1011 and the first operator 1041 moves away from the television 1011 (right section in FIG. 4). The distance between the television 1011 and the first operator 1041 after the movement may be relatively small. In other words, the position of the first operator 1041 in the right section may be identical to that in the left section. Upon receipt of the position information items from the position information obtaining unit 2032, the gesture operation area setting unit 2042 sets the dimensions of the screen area of the screen 1012 associated with the first operator 1041 who is relatively more distant from the television 1011 to be larger than those of the screen 1013 associated with the second operator 1041 who is relatively closer to the television 1011. As illustrated in FIG. 4, for example, in the right section, a length 1012zR of the screen 1012 associated with the first operator 1041 in the direction Dy may be longer than a length 1013zR of the screen 1013 associated with the second operator 1042, whereas in the left section, a length 1012zL does not have to be longer than a length 1013zL.

FIG. 5 illustrates another screen display of the television 1011 according to Embodiment 1.

In the left section of FIG. 5, the first operator 1041 is to the left of the second operator 1042 toward the television 1011, and a distance between the television 1011 and the first operator 1041 is almost identical to that between the television 1011 and the second operator 1042. In this case, with the processing described in FIG. 3, the screen 1012 and the screen 1013 are allocated to the first operator 1041 and the second operator 1042, respectively.

Here, assume a case where the position relationship between the first operator 1041 and the second operator 1042 is reversed (right section in FIG. 5). Upon receipt of the position information items from the position information obtaining unit 2032, the gesture operation area setting unit 2042 again sets the gesture operation area by replacing the position of the screen 1012 allocated to the first operator 1041 with the position of the screen 1013 allocated to the second operator 1042. Specifically, the first operator 1041 may be to the left and the screen 1012 allocated to the first operator 1041 may be to the left as illustrated in the left section of FIG. 5. Conversely, the first operator 1041 may be to the right and the screen 1012 allocated to the first operator 1041 may be to the right as illustrated in the right section of FIG. 5.

According to the setting as above, a gesture operation area can be set on a television screen according to the number and positions of operators in front of the television, and thus each of the operators can operate the television with a natural gesture operation. Furthermore, the gesture operation area can be set according to the movement of the operator.

In the image generation device according to Embodiment 1, more specifically, when the information obtaining unit detects change in a position of the operator (for example, operator 1041) that is indicated by a position information item, the image generation unit may again set, to a display area (1011P), an operating area (screen 1012) corresponding to the operator from which the change in the position has been detected, and a layout of the display area. In other words, after the detection (right section in FIG. 4), an area (screen 1012R) different from the area (screen 1012L) before the detection (left section) may be displayed as an operation area (screen 1012) of the user (1041), for example.

The information obtaining unit may further include not only the position information obtaining unit 2032 but also other constituent elements, such as the gesture recognition sensor 1021.

Furthermore, the information obtaining unit may obtain a position information item using, for example, a device such as a remote control that detects a position of a gesture operation of an operator (1041, etc.) and is held in the hand of the operator. In other words, the information obtaining unit may obtain the position information item for identifying the detected position that is to be uploaded (for example, through wireless communication) from such a device to the information obtaining unit.

For example, the information obtaining unit may obtain parallax information for identifying positions with a distance causing a particular parallax, by identifying a parallax between two images. The parallax information may be, for example, the two images.

Furthermore, the information obtaining unit may obtain only a 2D image out of the 2D image and the depth image that are described above. For example, the size of a part or an entire of an image of the operator in the obtained 2D image may be determined based on analysis on the 2D image. The size of the image is smaller as the distance between a display area of one operator and the other operator who has performed the gesture operation is smaller. The position calculated from the distance corresponding to the determined size may be determined as a position of a gesture operation.

Furthermore, the obtained position information item may be information indicating a position of the operator 104 detected by a sensor, such as a position of a foot. For example, the sensor is placed on a floor surface in the room where the television 1011 is placed.

After a plurality of position information items including the position information items of the first operator 1041 and the second operator 1042 are obtained, a plurality of screens 1011S (screens 1012 and 1013) corresponding to a plurality of gesture operations indicated by the position information items may be displayed.

Specifically, the position information items may be position information items of different operators 104 (1041 and 1042). The screens 1011S corresponding to the operators 104 may be displayed.

In contrast, the position information items may be position information items of a plurality of gesture operations performed by one operator, such as a position information item of a position at which a gesture operation is performed by the left hand of the operator and a position information item of a position at which a gesture operation is performed by the right hand of the operator. The screens 1011S corresponding to the gesture operations performed by the operator may be displayed.

### Embodiment 2

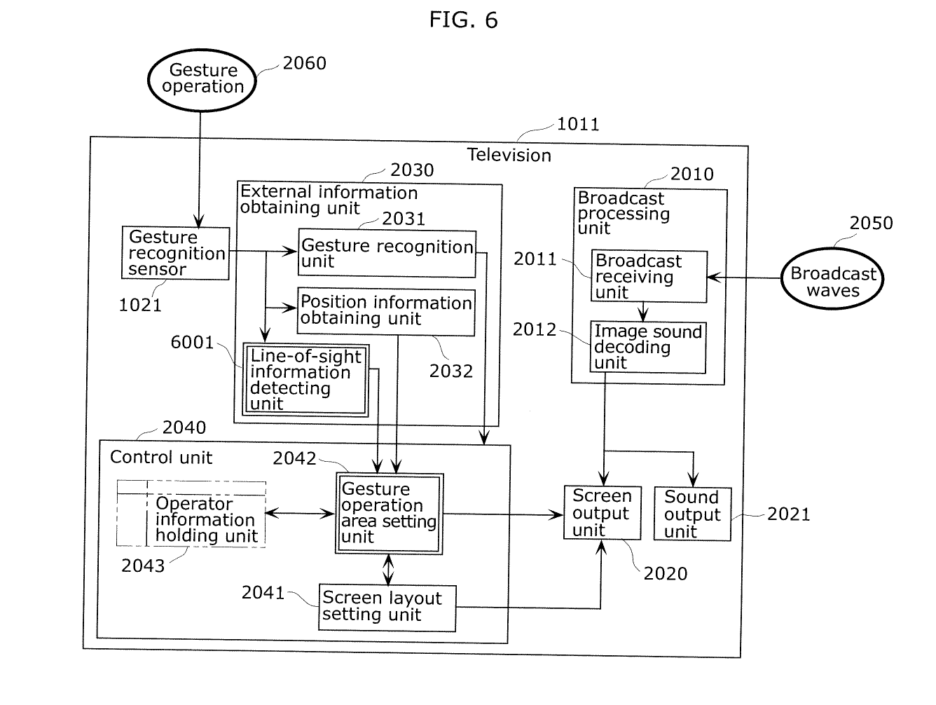

FIG. 6 is a block diagram illustrating a configuration of a television according to Embodiment 2 in the present disclosure.

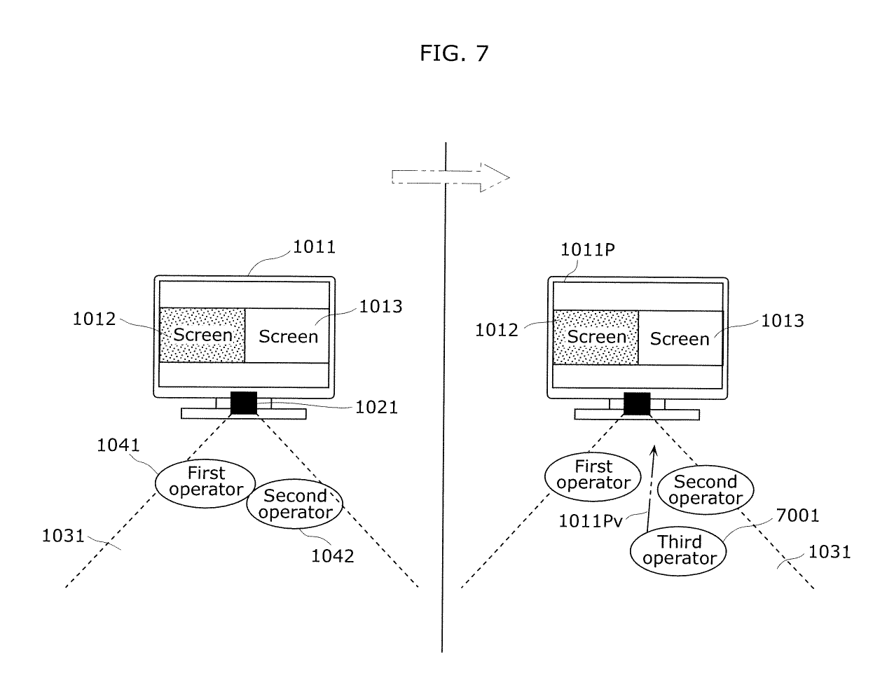

FIG. 6 is a diagram obtained by adding a line-of-sight information detecting unit 6001 to FIG. 1. The line-of-sight information detecting unit 6001 is implemented by, for example, a camera and the image recognition technique. The line-of-sight information detecting unit 6001 detects a position of an area on a television screen that is viewed by an operator in front of the television 1011. For example, the line-of-sight information detecting unit 6001 may detect a direction of a line of sight of an operator, such as a line of sight 1011Pv of a third operator 7001 in FIG. 7 to determine an area (for example, the screen 1013) viewed in the detected direction of the line of sight as the area viewed by the operator.

FIG. 7 illustrates another screen display of the television 1011 according to Embodiment 2.

With the process for setting a gesture operation area according to Embodiment 1, the screen 1012 and the screen 1013 are associated with the first operator 1041 and the second operator 1042, respectively (left section of FIG. 7). Furthermore, the line-of-sight information detecting unit 6001 detects that the first operator 1041 and the second operator 1042 view the screen 1012 and the screen 1013, respectively.

Here, as illustrated in the right section of FIG. 7, assume a case where the third operator 7001 enters the gesture recognition range 1031 and views, for a predetermined period, the screen 1013 without performing any gesture operation. In this case, the line-of-sight information detecting unit 6001 detects that the third operator 7001 views the screen 1013 and notifies the gesture operation area setting unit 2042 of the information (viewing information). Upon receipt of this notification, the gesture operation area setting unit 2042 stores, in the operator information holding unit 2043, information of the third operator 7001 and the screen 1013 in association with each other. When the third operator 7001 performs an operation on the television 1011 based on this association, the gesture operation area setting unit 2042 processes the operation as the gesture operation for the screen 1013 associated with the third operator 7001 without splitting the television screen into new sub-screens.

With the setting of a gesture operation area, even when one screen area is viewed by a plurality of viewers, the gesture operation area can be appropriately set.

As such, for example, the viewing information (line-of-sight information) indicating that the third operator 7001 views at least one of the screens (screens 1012 and 1013) in the display area 1011P or does not view any of the screens may be detected. The viewing information may indicate that any one of the screens is viewed or none of the screens is viewed, based on whether the line of sight indicates a predetermined direction as described above. When the viewing information indicates that any one of the screens is viewed, the screen is not newly split, the screens whose number is identical to that of the screens before the detection (two of the screens 1012 and 1013) may be displayed after the detection, and the number does not have to be increased (changed). Only when the viewing information indicates that none of the screens is viewed, the screen is newly split to increase the number of screens (for example, from 2 to 3).

For example, in the image generation device, (i) the information obtaining unit may detect the viewing information (line-of-sight information) indicating whether or not the third operator 7001 views one of the screens of a display area, and (ii) the image generation unit may change (increase) the number of operation areas in the display area by newly splitting the display area only when the detected viewing information indicates that the third operator 7001 views none of the screens, and does not have to change (increase) the number of operation areas by not newly splitting the display area when the detected viewing information indicates that the third operator 7001 views one of the screens.

### Embodiment 3

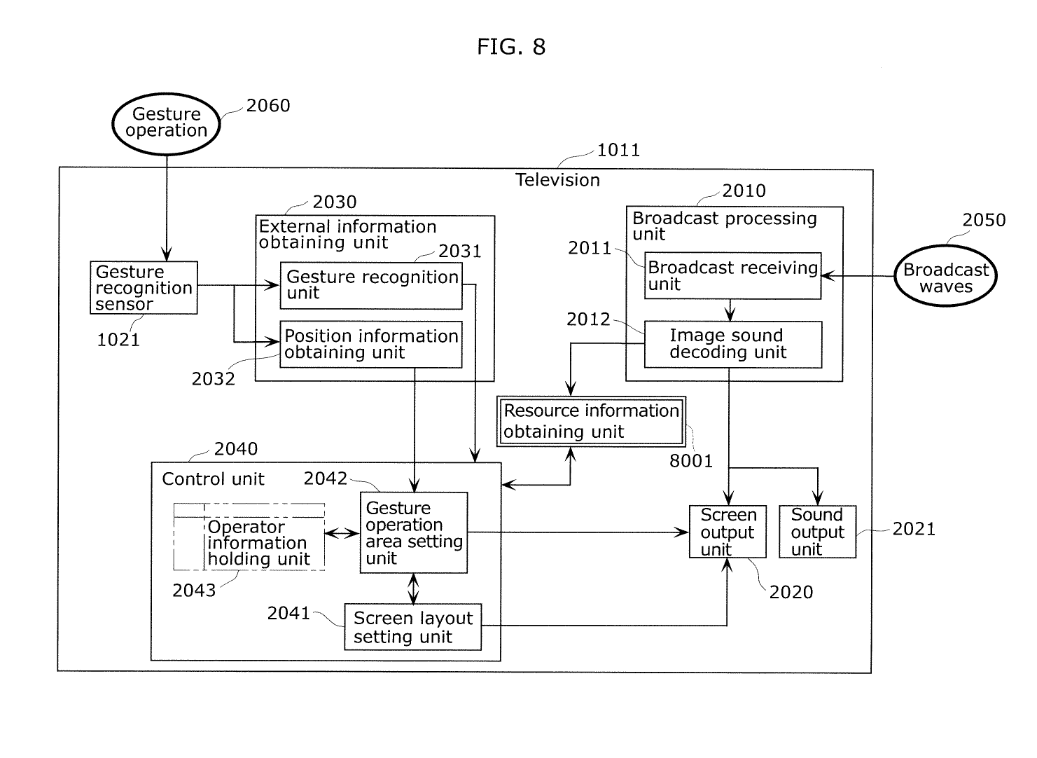

FIG. 8 is a block diagram illustrating a configuration of a television according to Embodiment 3 in the present disclosure.

FIG. 8 is a diagram obtained by adding a resource information obtaining unit 8001 to FIG. 1. The resource information obtaining unit 8001 obtains constraint information on functions or performance of the image sound decoding unit 2012, and notifies the control unit 2040 of the constraint information. The resource information obtaining unit 8001 notifies, for example, that a television screen can be split into two screens at most. In other words, the resource information obtaining unit 8001 may notify the constraint information for identifying the maximum number of screens into which the television screen can be split (two in the above case).

The gesture operation area setting unit 2042 uses the information from the resource information obtaining unit 8001 when setting a gesture area. For example, even when the third operator performs a gesture operation on a television screen and the resource information obtaining unit 8001 indicates that the television screen can be split only into two screens, the television screen will never be split again.

With the setting above, a gesture operation area can be set according to the constraints on functions or performance of each television.

As such, the image generation device may include the resource information obtaining unit (8001) that obtains resource information (constraint information) for identifying a use state of at least one of a CPU and an image decoder. The image generation unit may change, for example, the number of operation areas to smaller than or equal to the maximum value indicated by the obtained resource information.

The constraint information identifies the maximum number of possible sub-screens and the maximum display size of an operation area (screen 1011S) to a display area (display area 1011P). The display size of the operation area may be changed to be smaller than or equal to the maximum size.

When a plurality of users (for example, operators 1041 and 1042) has a first position relationship, an image may be generated in a first layout appropriate for the first position relationship as illustrated in the left section of FIG. 4. In contrast, when the plurality of users has a second position relationship, an image may be generated in a second layout appropriate for the second position relationship as illustrated in the right section of FIG. 4.

The position relationship may be represented by proximity from one of the operators (for example, the second operator 1042) to the television 1011, compared to that of the other operator (the first operator 1041) as illustrated in FIG. 4. In other words, the position relationship may be a relationship between two positions in a direction (direction Dz).

Similarly, the position relationship may be a relationship between two positions in the direction Dx (horizontal direction of the display area 1011P) with reference to FIG. 5.

Furthermore, the number of screens 1011S in a certain layout (for example, one in the left section of FIG. 3) may be different from that in another layout (two in the right section of FIG. 3).

Furthermore, a dimension of a certain screen (for example, length 1012zL in the left section of FIG. 4) may be different from that in another layout (length 1012zR in the right section of FIG. 4).

Furthermore, a ratio between the dimension of one screen and the dimension of the other screen in a layout may be different from a ratio between the dimension of the one screen and the dimension of the other screen in another layout. For example, a ratio between the length 1012zL of the screen 1012 and the length 1013zL of the screen 1013 in the left section of FIG. 4 may be different from a ratio between the length 1012zR of the screen 1012 and the length 1013zR of the screen 1013 in the right section.

Furthermore, a position of a certain screen in a layout may be different from that in another layout. For example, the position of the screen 1012 to the left in the left section of FIG. 5 may be different from that to the right in the right section.

Furthermore, the display area 1011P may be split into a plurality of screens 1011S at different positions in a certain direction in a layout. For example, in the right section of FIG. 3, the display area 1011P may be split into the screen 1012 at a position P1 and the screen 1013 at a position P2 in the horizontal direction Dx, in a layout having a plurality of the screens 1011S. Here, the display area 1011P may be split in a direction other than the direction Dx, for example, a vertical direction Dy (illustration is omitted).

Furthermore, in a certain layout, the screens 1011S may be displayed in Picture-in-Picture mode.

The layout may be, for example, a mode applied to the screens 1011S identified by one or more elements, such as the number (see FIG. 3) and the dimension (see FIG. 4) of the screens 1011S. In other words, layouts may be prepared in advance, and one of the layouts may be selected and set.

An integrated circuit 2040x (FIG. 2) including the external information obtaining unit 2030 and the control unit 2040 may be constructed. The integrated circuit 2040x generates layout information for identifying a layout using the control unit 2040 and generates an image in the layout identified by the generated layout information.

In the previous example of displaying an image on a wall, the screen for the user (one of the operators) is displayed in front of the user. The screen is an appropriate screen in which sub-screens do not overlap with one another when the user and another user have a relatively-distant first position relationship, whereas the screen is not an appropriate screen in which the sub-screens overlap with one another when the user and the other user have a relatively-close second position relationship.

Thus, it is not possible to appropriately display an image on a wall in the aforementioned example.

In response to this, the next operations may be performed on the image generation device (television 1011).

Specifically, the image generation device may be a television (1011) that is placed in a living room in a household and displays the generated image.

A predetermined user may be one of the persons who is present in the living room, views the television 1011, and lives in the household, for example, the first operator 1041 from among the operators 1041 and 1042 in FIG. 4. The predetermined user may use the image generation device by viewing the generated image to be displayed.

Then, the operation area (screen 1012) in which the predetermined user (1041) performs a gesture operation may be displayed.

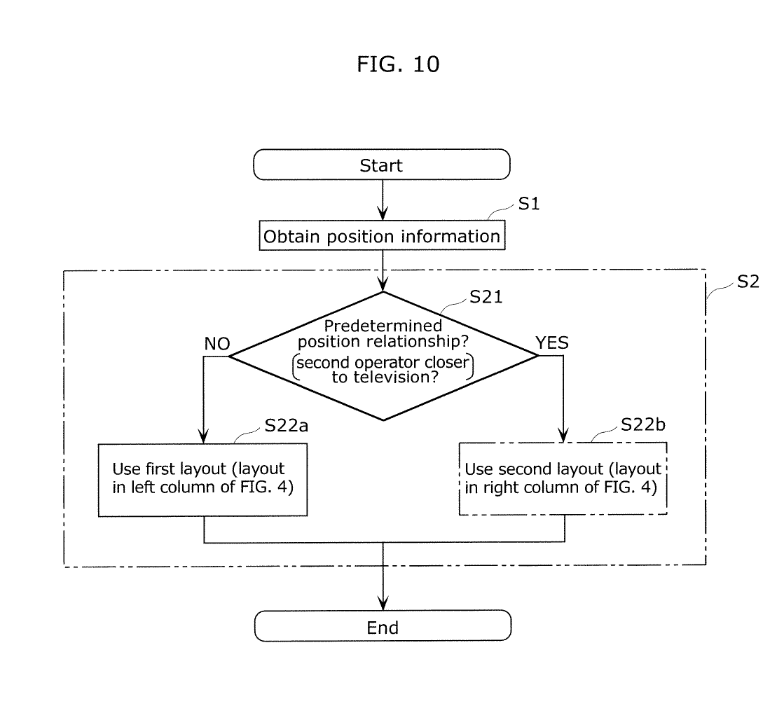

The position information obtaining unit 2032 may obtain information for identifying the position of the other user relative to the position of the user as a first relative position or a second relative position (51 in FIG. 10). For example, the position information obtaining unit 2032 obtains a relative position information item for identifying whether the second operator 1042 (position 1042L) is not closer to the television 1011 than the first operator 1041 as in the left section of FIG. 4 (first position relationship) or the second operator 1042 (position 1042R) is closer to the television 1011 than the first operator 1041 as in the right section of FIG. 4 (second position relationship).

Here, when the relative position of the other user (operator 1042) is in the first relative position (left section), the operation area of the user (operator 1041) may be at a relative position at which the first area (screen 1012L in the left section of FIG. 4) is appropriately displayed or at a relative position (right section of FIG. 4) at which the second area (screen 1012R) is appropriately displayed.

Only when the relative position indicated by the obtained relative position information item is the first relative position (No at S21, left section of FIG. 4), a generation unit 2020x in FIG. 2 may display the first area (screen 1012L) as the operation area (screen 1012) (S22a), whereas when the relative position is the second relative position (Yes at S21, right section of FIG. 4), the generation unit 2020x may display the second area (screen 1012R) (S22b).

Accordingly, the second area is appropriately displayed not only when the other user (operator 1042) is at the first relative position (position 1042L in the left section of FIG. 4) but also when the other user is at the second relative position (position 1042R in the right section of FIG. 4). Thus, the appropriate display is possible regardless of the position of the other user (relative position relationship with the other user).

In other words, the appropriate display is possible using the first layout in which the first area (screen 1012L) appropriate for the first position relationship (first relative position in the left section of FIG. 4) is displayed, when the other user has the first position relationship, and using the second layout in which the second area (screen 1012R) appropriate for the second position relationship (second relative position in the right section of FIG. 4) is displayed, when the other user has the second position relationship.

The relative position information item to be obtained may be information for identifying a relative position relationship between a predetermined operator and the other operator based on their positions, a distance between them, and their orientations.

Thus, a format (length 1012zL, properties, attributes, area, lengths, dimensions, position of the screen 1012L, and others) in which the image in the display area 1011P includes the screen 1012L corresponding to the first operator 1041 may be different from a format (length 1012zR, etc.) in which the image in the display area 1011P includes the screen 1012R corresponding to the first operator 1041.

While the image generation device includes a plurality of constituent elements to ensure the appropriate display, the wall in the aforementioned example lacks a part or all of the constituent elements and cannot appropriately display the image. In this regard, the image generation device is different from the conceivable other techniques including the wall.

In addition, in the display example on the wall, originally, the other user is rarely at the closer second relative position, and the relative position is easily moved away to the more distant first relative position. Thus, each of the operators is appropriately associated with the screen of the operator, and thus, a problem hardly occurs, and no one would have conceived a configuration that solves the problem.

A part (or entire) of the operations performed by the image generation device may be performed only in a certain phase and does not have to be performed in other phases.

In other words, the image generation device according to Embodiment 3 may be a television (1011) or a set-top box (1011T) that is placed in a living room in a household and displays an image viewed by a person who lives in the household.

Then, the image generation device may obtain a position information item for identifying a position of the other user (the second operator 1042 in FIG. 4) except a predetermined user (the first operator 1041).

The following describes a case where the second operator 1042 identified by the obtained position information item is at the first position (position 1042L in the left section of FIG. 4). The first position conforms to the first layout, for example, the layout in the left section of FIG. 4. In the display area 1011P, an image is displayed in the first layout. In other words, the first image corresponding to the second operator 1042 is displayed in the first layout within the screen 1013 having the length 1013zL.

The following describes a case where the second operator 1042 identified by the obtained position information item is at the second position (position 1042R in the right section of FIG. 4). The second position conforms to the second layout, for example, the layout in the right section of FIG. 4. In the display area 1011P, an image is displayed in the second layout. In other words, the second image corresponding to the second operator 1042 is displayed in the second layout within the screen 1013 having the length 1013zR.

Accordingly, even when the second operator 1042 is at the second position, the second area (screen 1012R) is displayed as the operation area of the first operator 1041. Thus, images are appropriately displayed regardless of the position of the other user.

The first position (position 1042L) may be a position within the first range (left section) and not closer to the television 1011 than the first operator 1041. Furthermore, the second position (position 1042R) may be a position within the second range (right section) and closer to the television 1011 than the first operator 1041.

As such, the first position (1042L) may be within the first range having the appropriate first area and identified from the position of the first operator 1041. Furthermore, the second position (1042R) may be within the second range having the appropriate second area and identified from the position of the first operator 1041.

The first position relationship (left section) may be a position relationship in which the position of the first operator 1041 is within the first range, and the first relative position may be within the first range. The second position relationship (right section) may be a relationship within the second range, and the second relative position may be within the second range.

In other words, the position relationship (relative position) may be information for identifying whether the first operator 1041 is within the first range or the second range. The information may include two position information items of the second operator 1042 and the first operator 1041, include only the position information item of the first operator 1041 when the first operator 1041 does not move, and include another position information item.

Setting a layout may be, for example, generating data of a layout to be set. The data to be generated may be data for identifying appropriate one of the first and second areas (screens 1012L and 1012R) corresponding to a range (first or second range) to which the second operator 1042 belongs, as the operation area (screen 1012) of the first operator 1041. In other words, the data to be generated may be data for generating an image (first or second image) in which the identified appropriate area (screen 1012 or 1012R) is displayed.

Accordingly, an appropriate area (screen 1012L or 1012R) is displayed regardless of the position of the second operator 1042 other than the first operator 1041, as the operation area (screen 1012) of the first operator 1041.

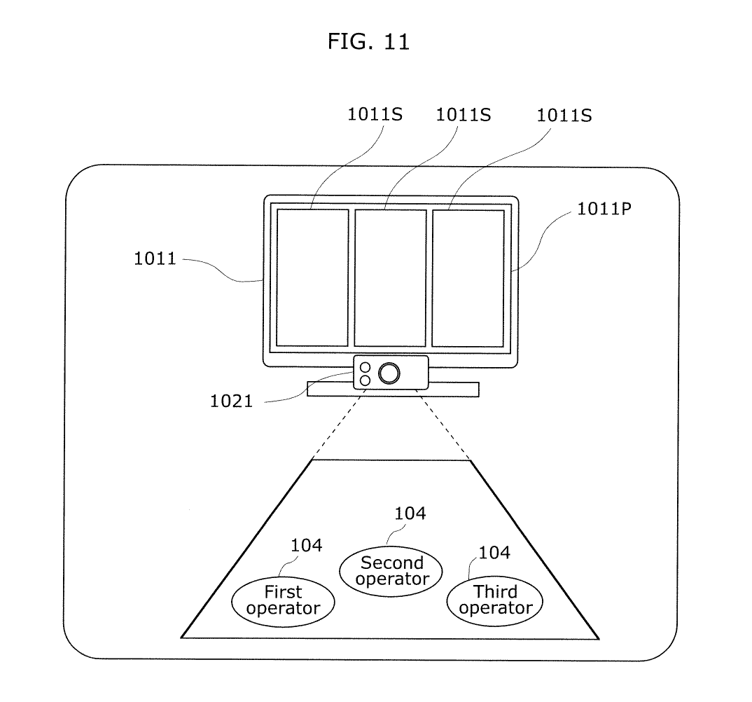

FIG. 11 illustrates a case where the number of operators 104 is three or more.

As described above, the number of operators 104 may be three or more. Furthermore, more than three screens 1011S may be displayed on the display area 1011P.

Here, FIG. 11 is an exemplification of a case where the number of operators 104 is three and the number of screens 1011S is three.

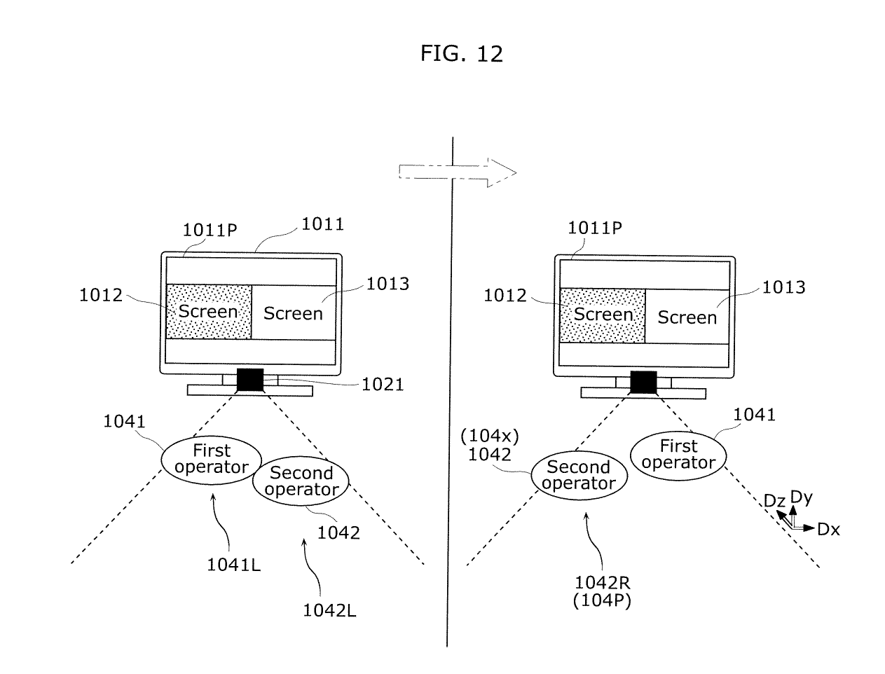

FIG. 12 illustrates an example of a display.

For example, the following may be displayed in a certain phase.

In the left section of FIG. 12, the first operator 1041 is to the left based on a position relationship between the first operator 1041 and the second operator 1042.

In the left section, the screen 1012 is to the left based on a position relationship between a portion in which the screen 1012 for the first operator 1041 is displayed and a portion in which the screen 1013 for the second operator 1042 is displayed.

Conversely, in the right section of FIG. 12, the first operator 1041 is to the right based on a position relationship between the first operator 1041 and the second operator 1042 that is different from the position relationship in the left section.

In the right section, the position relationship between the screen 1012 and the screen 1013 in which the screen 1012 is to the left remains the same as in the left section.

In other words, the layout of the screens 1012 and 1013 in the right section remains the same as that in the left section.

Regardless of change in the position relationship between the two operators (1041 and 1042), the layout of the screens 1012 and 1013 after changing the position relationship (right section) may be identical to that before the change (left section), and may remains the same.

The following operations may be performed.

FIGS. 5 and 12 illustrate states where a television screen is split into an area A (screen 1012) and an area B (screen 1013).

The first case is that the number of operators who view the area A is one and the number of operators who view the area B is also one.

In contrast, the second case is that the number of operators who view the area A is two and the number of operator who views the area B is one.

Thus, in the first case, the screens may be replaced with one another as illustrated in FIG. 5 after the positions of the operators are replaced with one another (right section of FIG. 5).

Furthermore, in the second case, after the position of one of the two operators who view the area A is changed, the operation in FIG. 12 is performed without the replacement in FIG. 5, thus the screens do not have to be replaced with one another.

In other words, the following operations may be performed.

Specifically, there are cases where two or more operators view one area (for example, area A) as in the second case.

Furthermore, there are cases where only one of the positions of the two operators who view the area is changed, and the position of the other is not changed.

Even when the position of the other operator is not changed, in the case where the screens are replaced with one another (see FIG. 5), the screens are inappropriately displayed.

Thus, whether or not such a situation has occurred may be determined.

Specifically, it may be determined whether or not two operators view one area (for example, area A) (condition C1) and the position of only one of the operators is changed (condition C2).

The determination may be performed by, for example, the control unit 2040.

The determination may be performed based on information indicating whether or not two or more operators view one area (for example, area A) or the operators view the same area.

The information may be obtained by, for example, the line-of-sight information detecting unit 6001 included in the television 1011 in FIG. 6.

The screens may be replaced or not (operation in FIG. 5 or FIG. 12) based on this determination.

Furthermore, the screens may be replaced or not (operation in FIG. 5 or FIG. 12) based on a condition (replacing condition).

FIG. 13 illustrates the television 1011 and others.

The television 1011 may include a plurality of speakers.

The speakers may be, for example, two speakers 1011a and 1011b for outputting stereo sound as illustrated in FIG. 13.

FIG. 13 schematically illustrates these speakers 1011a and 1011b for convenience of the drawing.

The speaker 1011a is placed to the left when the viewer views the display area 1011P of the television 1011 in the direction Dz in FIG. 13, and outputs a sound 4a from the left position.

The speaker 1011b is placed to the right, and outputs a sound 4b from the right position.

FIG. 13 also illustrates the first operator 1041 to the left and the second operator 1042 to the right.

The first operator 1041 views the screen 1012 to the left, and the second operator 1042 views the screen 1013 to the right.

The speaker 1011a to the left may output the sound 4a as the sound of the screen 1012 that is heard by the first operator to the left.

The speaker 1011b to the right may output the sound 4b as the sound of the screen 1013 that is heard by the second operator to the right.

The control unit 2040 may perform such operations.

The sound of the screen (1012 or 1013) of each of the operators may be output from a corresponding one of the speakers 1011a and 1011b.

Each of the sounds may be output from an appropriate one of the speakers 1011a and 1011b which corresponds to the position of the operator of the screen.

The next operations may be performed.

A normal position at which a sound image of a sound is pinpointed is a position at which the sound seems to be generated.

Control may be performed to move the normal position of the sound from the left screen 1012 to the left and the normal position of the sound from the right screen 1013 to the right.

Specifically, the output from the left speaker 1011a and the output from the right speaker 1011b are balanced when each of the speakers outputs the sound.

In other words, the output from the left speaker 1011a may be relatively larger than that from the right speaker 1011b when the sound of the left screen 1012 is output.

Conversely, the output from the left speaker 1011a may be relatively smaller than that from the right speaker 1011b when the sound of the right screen 1013 is output.

A sound may be output based on the output balance between the two speakers 1011a and 1011b to correspond to a position of the operator who listens to the sound.

For example, output of the sound based on the balance corresponding to the position of the operator may determine a normal position at which the sound is output based on such a balance, and the sound may be output at an appropriate normal position.

Furthermore, the next operations may be performed.

Specifically, in a certain phase as illustrated in the right section of FIG. 4, the first operator 1041 may be relatively distant from the television 1011 and conversely, the second operator 1042 may be relatively close to the television 1011.

Thus, a louder sound (large volume of sound or sound with a larger amplitude) may be output as the sound of the screen 1012 of the first operator 1041 at a distance.

A smaller sound may be output as the sound of the screen 1013 of the second operator 1042 in proximity.

For example, the control unit 2040 may control the operations as such.

A sound with an appropriate volume corresponding to the position of the operator with respect to the screen may be output as the sound of each of the screens (1012 and 1013).

When the sound of the screen is output, the output may be controlled.

The appropriate control corresponding to the position of the operator (first operator 1041) for the screen (screen 1012) may be performed from among a plurality of controls when the sound of each of the screens is output.

The next operations may be performed when the screen in the right section of FIG. 12 is displayed.

Specifically, one of the screens 1012 and 1013 may be identified in the example of FIG. 12.

In other words, one of the operators (1041 and 1042) may be identified as the operator 104x for which the position 104P has been detected.

Furthermore, as described above, the operator information holding unit 2043 and others may store the association between each of the operators and the screen of the operator.

Furthermore, the screen (1013) in association with the identified operator (1042) may be identified.

The gesture operation of the operator 104x at the detected position 104P may be identified as the operation for the identified screen (1013).

Accordingly, the gesture operation at the position 104P is identified as an operation for an appropriate screen (1013), thus enabling appropriate processing.

More specifically, an image representing the characteristics of the appearance of the operator 104x for which the position 104P has been detected may be captured (see the gesture recognition sensor 1021 in FIG. 2).

Furthermore, the control unit 2040 may store data for identifying the characteristics of each of the operators.

Then, the operator whose image is included in the captured image and which has the same characteristics as those of the operator 104x at the position 104P may be identified as one of the operators.

Such processing may be image recognition.

In recent years, some digital still cameras perform image recognition. The image recognition used as the technique herein may be such processing by digital still cameras.

Furthermore, the position of the operator 104x for which the position 104P has been detected may be identified as the position 1042L at a time (left section of FIG. 12) previous to the detected time (right section of FIG. 12).

Furthermore, one of the operators (1041 and 1042) who was at the position 1042L at the previous time may be identified as the one of the operators.

The present disclosure described based on Embodiments is not limited to these Embodiments. The present disclosure includes an embodiment with some modifications on Embodiments conceived by a person skilled in the art. Furthermore, the present disclosure includes another embodiment obtained through arbitrary combinations of the constituent elements described in Embodiments that are described in different sections of the Description.

Furthermore, the present disclosure can be implemented not only as such a device but also as a method using processing units included in the device as steps. Furthermore, the present disclosure can be implemented as a program causing a computer to execute such steps, as a recording medium on which the program is recorded, such as a computer-readable CD-ROM, and as an integrated circuit having functions of the device.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

When a television screen is split into sub-screens and the sub-screens are allocated to a plurality of operators, the present disclosure enables appropriate control on the display positions and dimensions of the sub-screens, according to a position relationship between the operators, distances between the operators and the sub-screens, and rearrangement of the positions of the operators. Furthermore, the sub-screens can be appropriately displayed regardless of the position relationship between the operators.

1. An image generation device, comprising:
an information obtaining unit configured to obtain position information items indicating positions of operators who perform gesture operations, and gesture operation information items indicating the gesture operations of the operators; and
an image generation unit configured to set a layout of an image, based on a relative position relationship between the positions of the operators that are indicated by the obtained position information items, and generate the image in the set layout corresponding to the position relationship,
wherein the information obtaining unit is configured to detect line-of-sight information of the operators with respect to a display area, and
the image generation unit is configured to:
set a plurality of operation areas operated by the gesture operations in the display area on which the generated image is displayed, according to the number of obtained gesture operation information items; and
change the number of operation areas set in the display area, based on the detected line-of-sight information.

2. The image generation device according to claim 1,
wherein when the information obtaining unit detects a change in the position information item of one of the operators, the image generation unit is configured to change a display size of a corresponding one of the operation areas that is operated by the gesture operation of the operator having the change in the position information item.

3. The image generation device according to claim 1,
wherein the layout to be set when the number of operation areas is more than one is a layout in which the display area is split, in a predetermined direction, into the operation areas at different positions.

4. The image generation device according to claim 1,
wherein the image generation device is a set-top box that displays the generated image on a display area of a television placed outside of the image generation device.

5. The image generation device according to claim 1,
wherein the image generation unit is configured to generate the image including the operation areas, in the layout that corresponds to the position relationship, each of the operation areas being at a display position and having a display size.

6. The image generation device according to claim 1,
wherein the generated image is an image in the layout corresponding to the position relationship only when a predetermined condition is satisfied, and is an image in an other layout when the predetermined condition is not satisfied, and the image in the other layout is an image in a layout identical to a layout of an image generated prior to the generation of the image in the other layout.

7. The image generation device according to claim 1,
wherein the image generation unit is configured to:
generate a first image in a first layout when the position relationship is a first position relationship, and perform first control for outputting a first sound corresponding to the first image; and
generate a second image in a second layout when the position relationship is a second position relationship, and perform second control for outputting a second sound corresponding to the second image.

8. The image generation device according to claim 7,
wherein the first control is control for outputting the first sound from one of two speakers, and
the second control is control for outputting the second sound from the other speaker.

9. An image generation device, comprising:
an information obtaining unit configured to obtain position information items indicating positions of operators who perform gesture operations;
an image generation unit configured to set a layout of an image, based on a relative position relationship between the positions of the operators that are indicated by the obtained position information items, and generate the image in the set layout corresponding to the position relationship; and
a resource information obtaining unit configured to obtain resource information on use states of a central processing unit (CPU) and an image decoder,
wherein the image generation unit is configured to:
set a plurality of operation areas operated by the gesture operations in the display area on which the generated image is displayed, according to the number of obtained gesture operation information items; and
change, based on the obtained resource information with respect to the display area, one of (i) display sizes of the set operation areas and (ii) the number of operation areas.

10. The image generation device according to claim 9,
wherein when the information obtaining unit detects a change in the position information item of one of the operators, the image generation unit is configured to change a display size of a corresponding one of the operation areas that is operated by the gesture operation of the operator having the change in the position information item.

11. The image generation device according to claim 9,
wherein the layout to be set when the number of operation areas is more than one is a layout in which the display area is split, in a predetermined direction, into the operation areas at different positions.

12. The image generation device according to claim 9,
wherein the image generation device is a set-top box that displays the generated image on a display area of a television placed outside of the image generation device.

13. The image generation device according to claim 9,
wherein the image generation unit is configured to generate the image including the operation areas, in the layout that corresponds to the position relationship, each of the operation areas being at a display position and having a display size.

14. The image generation device according to claim 9,
wherein the generated image is an image in the layout corresponding to the position relationship only when a predetermined condition is satisfied, and is an image in an other layout when the predetermined condition is not satisfied, and the image in the other layout is an image in a layout identical to a layout of an image generated prior to the generation of the image in the other layout.

15. The image generation device according to claim 9,
wherein the image generation unit is configured to:
generate a first image in a first layout when the position relationship is a first position relationship, and perform first control for outputting a first sound corresponding to the first image; and
generate a second image in a second layout when the position relationship is a second position relationship, and perform second control for outputting a second sound corresponding to the second image.

16. The image generation device according to claim 15,
wherein the first control is control for outputting the first sound from one of two speakers, and
the second control is control for outputting the second sound from the other speaker.

17. An image generation method, comprising:
obtaining position information items indicating positions of operators who perform gesture operations, and gesture operation information items indicating the gesture operations of the operators; and
setting a layout of an image, based on a relative position relationship between the positions of the operators that are indicated by the obtained position information items, and generating the image in the set layout corresponding to the position relationship,
wherein the obtaining includes detecting line-of-sight information of the operators with respect to a display area, and
the setting and the generating includes:
setting a plurality of operation areas operated by the gesture operations in the display area on which the generated image is displayed, according to the number of obtained gesture operation information items; and
changing the number of operation areas set in the display area, based on the detected line-of-sight information.

18. An image generation method, comprising:
obtaining position information items indicating positions of operators who perform gesture operations;
setting a layout of an image, based on a relative position relationship between the positions of the operators that are indicated by the obtained position information items, and generating the image in the set layout corresponding to the position relationship; and
obtaining resource information on use states of a central processing unit (CPU) and an image decoder,
wherein the setting and the generating includes:
setting a plurality of operation areas operated by the gesture operations in the display area on which the generated image is displayed, according to the number of obtained gesture operation information items; and
changing, based on the obtained resource information with respect to the display area, one of (i) display sizes of the set operation areas and (ii) the number of operation areas.

19. An integrated circuit, comprising:
an information obtaining unit configured to obtain position information items indicating positions of operators who perform gesture operations, and gesture operation information items indicating the gesture operations of the operators; and
an image generation unit configured to set a layout of an image, based on a relative position relationship between the positions of the operators that are indicated by the obtained position information items, and generate the image in the set layout corresponding to the position relationship,
wherein the information obtaining unit is configured to detect line-of-sight information of the operators with respect to a display area, and
the image generation unit is configured to:
set a plurality of operation areas operated by the gesture operations in the display area on which the generated image is displayed, according to the number of obtained gesture operation information items; and
change the number of operation areas set in the display area, based on the detected line-of-sight information.

20. An integrated circuit, comprising:
an information obtaining unit configured to obtain position information items indicating positions of operators who perform gesture operations;
an image generation unit configured to set a layout of an image, based on a relative position relationship between the positions of the operators that are indicated by the obtained position information items, and generate the image in the set layout corresponding to the position relationship; and
a resource information obtaining unit configured to obtain resource information on use states of a central processing unit (CPU) and an image decoder,
wherein the image generation unit is configured to:
set a plurality of operation areas operated by the gesture operations in the display area on which the generated image is displayed, according to the number of obtained gesture operation information items; and
change, based on the obtained resource information with respect to the display area, one of (i) display sizes of the set operation areas and (ii) the number of operation areas.
